(19) United States
(12) Patent Application Publication
(10) Pub. No.: US 2026/0286207 A1
(43) Pub. Date: Sep. 24, 2026

(54) EMULSIFIERS, DRILLING FLUIDS, AND METHODS OF MAKING AND USING THE SAME

(71) Applicant: INGEVITY SOUTH CAROLINA, LLC, North Charleston, SC (US)

(72) Inventor: Devin B. Granger, North Charleston, SC (US)

(21) Appl. No.: 19/478,712

(22) PCT Filed: May 21, 2024
(86) PCT No.: PCT/US2024/030341

§ 371 Date: Oct. 24, 2025

Related U.S. Application Data
(60) Provisional application No. 63/503,546, filed on May 22, 2023.

(51) Int. Cl. C09K 8/36; E21B 21/06

(52) U.S. Cl. CPC C09K 8/36; E21B 21/062

(57) ABSTRACT

The present disclosure describes an emulsifier and methods of making and using the same. The emulsifier made by reacting (A) a fatty acid composition with (B) one or more (e.g., 1, 2, 3, 4, 5, 6, or more) poly(alkylamine) to produce a partial amide, and reacting (a) the partial amide with (b) an acid and/or anhydride composition that includes or is a dicarboxylic acid, a di-anhydride, a tricarboxylic acid, a tri-anhydride, or a mixture thereof, to produce the emulsifier, wherein the fatty acid composition comprises at least about 60% C₁₆₋₁₈ fatty acids and at least 65% saturated fatty acids (e.g., at least 85% saturated fatty acids). The present disclosure further describes a drilling fluid including the emulsifier of the present disclosure, as well as methods of making and using the same.

### CROSS-REFERENCE TO RELATED APPLICATIONS

This application claims priority to, and the benefit of, U.S. Provisional Patent Application No. 63/503,546, filed 22 May 2023 and titled EMULSIFIERS, DRILLING FLUIDS, AND METHODS OF MAKING AND USING THE SAME, which is incorporated by reference herein in its entirety for all purposes.

### TECHNICAL FIELD

The present disclosure relates to an emulsifier that is solid at room temperature without the use of support material. The present disclosure also relates to methods of making the emulsifier, drilling fluids comprising the emulsifier, and methods of drilling a wellbore.

### BACKGROUND

A drilling fluid (also known as “mud”) is a specially designed fluid that is circulated through an oil or gas wellbore as the wellbore is drilled to facilitate the drilling operation. The drilling fluid can be a water-based drilling fluid (water-based mud) or an oil-based drilling fluid (oil-based mud).

Oil-based drilling fluid or mud is a widely used drilling fluid in oil and gas production industry. Drilling fluids or muds are used to cool the bit, lubricate the drill string, suspend and transport cuttings, control hydrostatic pressure, and maintain stability. Oil-based drilling fluids or muds, which are also referred to as invert emulsion drilling fluids, are composed of oil as a continuous phase and water as a dispersed phase together with emulsifiers, wetting agents, gellants, etc. The oil phase typically comprises diesel, kerosene, fuel oil, crude oil, or mineral oil. Water-based drilling fluids or muds are composed of water as a continuous phase and oil as a dispersed phase together with, e.g., viscosifiers, fluid loss control agents, weighting agents, lubricants, emulsifiers, corrosion inhibitors, salts, pH control agents, etc.

Known invert emulsion drilling fluid emulsifiers suffer from issues with their pour point in cooler temperatures (such as, those experienced during the winter and in cold climates), thereby limiting their use in these conditions or requiring special equipment to warm the emulsifier before use. Powdered emulsifiers avoid cold temperature issues due to their free-flowing nature, even at cold temperatures. However, all known commercial dry secondary emulsifiers incorporate a solid support (e.g. silica) to avoid issues with the physical property of the dried emulsifier or secondary emulsifiers (e.g. tackiness and caking), thereby maintaining the free-flowing nature of the powder. The use of solid support results in a dilution of the emulsifier in the end product, and results in settling of the solid support in mud pits and unwelcome abrasion issues, depending on the abrasive nature of the particular solid support.

Historically, secondary emulsifiers for invert emulsion drilling fluids or muds incorporate tall-oil fatty acids (TOFA) as a raw material. These emulsifiers are semi-solid at room temperature, tacky, and not well suited to producing powdered products. As discussed above, these emulsifiers can be mixed with a solid support material (e.g., silica) to allow processing into powders, but this dilutes the activity of the emulsifier by the portion of support added. Furthermore, liquid secondary emulsifiers include additives (such as diluents, pour point depressants, and the like) to address the high viscosity of the amidoamine reaction products. Thus, liquid emulsifiers also dilute the activity of the emulsifier by the required additives. Indeed, for a great deal of amidoamine chemistry, a solvent package, vide supra, is required because the amidoamine reaction product is pasty and thus, not a practical or commercially viable form for an emulsifier. As a result, the dilution of solid and liquid emulsifiers requires the usage of additional emulsifier in the application, thereby increases the cost and can impact the properties and performance of the fluid/mud.

Thus, there is a need for a powdered emulsifier for invent emulsions, such as invert emulsion drilling fluid, that does not require spray drying or solid supports. The present disclosure provides a solid secondary emulsifier that does not require spray drying or solid supports and solidifies from the reaction melt. The solid emulsifier of the present disclosure maintains its form as a free-flowing powder, thereby decreasing the amount of processing required.

### SUMMARY

Presently described are emulsifiers (e.g., secondary emulsifiers), as well as methods of making and using the same, and drilling fluids or muds, as well as methods of making and using the same.

An aspect of the present disclosure provides an emulsifier, or emulsifier reaction product, made by a process comprising, consisting essentially of, or consisting of: reacting (A) a fatty acid composition with (A) one or more (e.g., 1, 2, 3, 4, 5, 6, or more) poly(alkylamine) to produce a partial amide; and reacting (a) the partial amide with (b) an acid and/or anhydride composition that includes, consists essentially of, or consists of a dicarboxylic acid, a di-anhydride, a tricarboxylic acid, a tri-anhydride, or a mixture thereof, to produce the emulsifier, wherein the fatty acid composition comprises, consists essentially of, or consists of at least about 60% C₁₆₋₁₈ fatty acids and at least 65% saturated fatty acids (e.g., at least 85% saturated fatty acids).

A further aspect of the present disclosure provides a method of making an emulsifier, or emulsifier reaction product, of the present disclosure. The method comprising, consisting essentially of, or consisting of: reacting (A) a fatty acid composition with (B) one or more (e.g., 1, 2, 3, 4, 5, 6, or more) poly(alkylamine) to produce a partial amide; and reacting (a) the partial amide with (b) an acid and/or anhydride composition that includes, consists essentially of, or consists of a dicarboxylic acid, a di-anhydride, a tricarboxylic acid, a tri-anhydride, or a mixture thereof, to produce the emulsifier, wherein the fatty acid composition comprises, consists essentially of, or consists of at least about 60% C₁₆₋₁₈ fatty acids and at least 65% saturated fatty acids (e.g., at least 85% saturated fatty acids).

In any aspect or embodiment described herein, (i) the emulsifier (or emulsifier reaction product) does not include a support material, a solid support, a solvent, a diluent, an adsorbent, a pour point depressant, any additives, or a combination thereof; (ii) the emulsifier (or emulsifier reaction product,) only includes the emulsifier reaction product; (iii) the emulsifier consists of the emulsifier reaction product; or (iv) a combination thereof.

In any aspect or embodiment described herein, the fatty acid composition comprises, consists essentially of, or consists of two or more (e.g., 1, 2, 3, 4, 5, 6, 7, 8, 9, 10, or more) C₁₆₋₁₈ fatty acid (e.g., a mixture of C₁₆₋₁₈ fatty acids or AltaVeg™ FA 450).

In any aspect or embodiment described herein, the fatty acid composition comprises, consists essentially of, or consists of: at least about 60% C₁₆ fatty acids (e.g., palmitic acid) and C₁₈ fatty acids (e.g., stearic acid); less than about 30% unsaturated C₁₈ fatty acids; or a combination thereof.

In any aspect or embodiment described herein, the fatty acid composition comprises, consists essentially of, or consists of: at least about 65% C₁₆ fatty acids (e.g., palmitic acid) and C₁₈ fatty acids (e.g., stearic acid); less than about 25% unsaturated C₁₈ fatty acids; or a combination thereof.

In any aspect or embodiment described herein, the fatty acid composition comprises, consists essentially of, or consists of at least 85% saturated fatty acids; the fatty acid composition includes, consists essentially of, or consists of palmitic acid, stearic acid, hydrogenated tallow fatty acids, or a mixture thereof; the fatty acid composition includes, consists essentially of, or consists of: at least about 65% C₁₆ fatty acids (e.g., palmitic acid) and C₁₈ fatty acids (e.g., stearic acid), less than about 10% C₁₈ fatty acids (e.g., stearic acid), and less than about 25% unsaturated C₁₈ fatty acids; or a combination thereof.

In any aspect or embodiment described herein, the poly(alkylamine) includes, consists essentially of, or consists of 1 to 12 carbon atoms (e.g., 3 to 9 or 4 to 8 carbon atoms), 1 to 7 nitrogen atoms (e.g., 2 to 6 or 3 to 5 nitrogen atoms), or a combination thereof (e.g., 1 to 12 carbon atoms and 1 to 7 nitrogen atoms, 4 to 8 carbon atoms and 3 to 5 nitrogen atoms, or 3 to 9 carbon atoms and 2 to 6 nitrogen atoms).

In any aspect or embodiment described herein, (i) the dicarboxylic acid includes, consists essentially of, or consists of a C₂₋₆ dicarboxylic acid (e.g., maleic acid, fumaric acid, succinic acid, or a mixture thereof); (ii) the di-anhydride includes, consists essentially of, or consists of a C₂₋₆ di-anhydride (e.g. maleic anhydride, succinic anhydride, or a mixture thereof); (iii) the tricarboxylic acid includes, consists essentially of, or consists of a C₃₋₈ tricarboxylic acid; (iv) the tri-anhydride includes, consists essentially of, or consists of a C₃₋₈ tri-anhydride, or (v) a combination thereof.

In any aspect or embodiment described herein, (i) the one or more poly(alkylamine) includes, consists essentially of, or consists of diethylenetriamine (DETA), triethylenetetramine (TETA), tetraethylenepentamine (TEPA), or a mixture thereof, (ii) the acid and/or anhydride composition includes, consists essentially of, or consists of maleic acid, fumaric acid, succinic acid, succinic anhydride, maleic anhydride, or a mixture thereof, or (iii) a combination thereof.

In any aspect or embodiment described herein, (i) the fatty acid composition is present in an amount of about 75 to about 90 wt % (e.g., about 78 to about 88 wt %) of the partial amide; (ii) the one or more poly(alkylamine) is present in an amount of about 10 to about 25 wt % (e.g., about 12 to about 22 wt %) of the partial amide; (iii) the partial amide is present in an amount of about 80 to about 95 wt % (e.g., about 85 to about 95 wt % or about 90 wt %) of the emulsifier; (iv) the acid and/or anhydride composition is present in an amount of about 5 to about 20 wt % (e.g., about 5 to about 15 wt % or about 10 wt %) of the emulsifier; or (v) a combination thereof.

In any aspect or embodiment described herein, (i) the molar ratio of the fatty acid composition to the poly(alkylamine) is about 1.85 to about 2.0; (ii) the molar ratio of the partial amide to the acid and/or anhydride composition is about 0.6 to about 1.0 (e.g., about 0.6 to about 0.75); or (iii) a combination thereof.

In any aspect or embodiment described herein, the emulsifier has an acid number of about 45 to about 80, an amine number of about 5 to about 15, or a combination thereof.

In any aspect or embodiment described herein, reacting the fatty acid composition with the poly(alkylamine) comprises, consists essentially of, or consists of: (i) heating the fatty acid composition (e.g., heating the fatty acid composition to the melting point of the fatty acid composition, such as about 50° C. to about 100° C.) to produce a molten fatty acid composition; (ii) adding the acid and/or anhydride composition to the fatty acid composition (e.g., a molten fatty acid composition); (iii) agitating the fatty acid composition and the one or more poly(alkylamine) reaction mixture; (iv) reacting the fatty acid composition and the acid and/or anhydride composition at about 145° C. to about 185° C. (e.g., about 150° C. to about 180° C. or about 150° C. to about 170° C.) until the acid number (AN) is less than about 20 mg/g, less than about 15 mg/g, or less than about 10 mg/g (e.g., reacting the fatty acid composition and the acid and/or anhydride composition for about 30 minutes to about 3 hours or about 1 hour to about 2.5 hours); or (v) a combination thereof.

In any aspect or embodiment described herein, reacting the partial amide with the acid and/or anhydride composition comprises, consists essentially of, or consists of: (i) heating the partial amide to about 100° C. to about 140° C. (e.g., about 110° C. to about 130° C., or about 120° C.); (ii) adding the acid and/or anhydride composition to the partial amide (e.g., adding the acid and/or anhydride composition while maintaining the temperature of the mixture below about 140° C., or about 120° C. to about 130° C., during the addition); (iii) agitating the partial amide and the acid and/or anhydride composition reaction mixture; (iv) reacting the partial amide and the acid and/or anhydride composition at about 130° C. to about 165° C. (e.g., about 130° C. to about 150° C. or about 130° C. to about 140° C.); (v) reacting the partial amide and the acid and/or anhydride composition for about 30 minutes to about 90 minutes (e.g., about 30 minutes to about 75 minutes, about 45 minutes to about 60 minutes, or about 45 minutes); or (vi) a combination thereof.

In any aspect or embodiment described herein, the process or method further comprises, consists essentially of, or consists of cooling the emulsifier (e.g. cooling the emulsifier to room temperature, about 18° C. to about 25° C., or about 20° C. to about 22° C.).

In any aspect or embodiment described herein, the emulsifier is a solid.

In any aspect or embodiment described herein, the process or method further comprises, consists essentially of, or consists of mechanically breaking the emulsifier solid to a particulate (e.g., emulsifier flakes, pellets, or powder).

Another aspect of the present disclosure provides an oil-based drilling fluid or mud comprising, consisting essentially of, or consisting of, an invert emulsion of a hygroscopic liquid (e.g., a brine, such as a CaCl₂ brine), one or more emulsifier, and at least one of: an oil, a mineral oil, a synthetic oil (e.g., one or more of an internal olefin, a poly alpha olefin, and a linear paraffin), or a combination thereof, wherein the one or more emulsifiers includes, consists essentially of, or consists of the emulsifier of the present disclosure, an emulsifier produced according to the method of the present disclosure, or a combination thereof.

In any aspect or embodiment described herein, (i) the one or more emulsifiers includes, consists essentially of, or consists of a primary emulsifier (e.g., modified tall oil and/or modified fatty amine condensate); (ii) the oil is diesel; (iii) the hygroscopic liquid is a CaCl₂ brine, a NaCl brine, a NaBr brine, a CaBr₂ brine, a formate brine, a potassium formate, an alcohol based hygroscopic liquid, a lower polyhydric alcohol, glycerol, or a polyglycerol (e.g., a CaCl₂ brine); or (iv) a combination thereof.

In any aspect or embodiment described herein, the drilling fluid or mud further comprises: (i) one or more weighting agent (e.g., barite); (ii) one or more rheological modifier (e.g., at least one of: a clay, an organophilic clay, a bentonite clay, an amine-treated clay, an amine-treated bentonite clay, a polyamide, a dimer diacid, or combinations thereof); (iii) one or more alkalinity agent (e.g., lime, CaO, or Ca(OH)₂); (iv) one or more wetting agent (e.g., a fatty imidazoline, a soya lecithin, or combinations thereof); or (v) a combination thereof.

In any aspect or embodiment described herein, the oil-based drilling fluid or mud comprises: an invert emulsion of a hygroscopic liquid (e.g., a brine, such as a CaCl₂ brine), an oil (e.g. diesel), a mineral oil, the emulsifier of the present disclosure, and an internal olefin.

An additional aspect of the present disclosure provides a method of drilling a wellbore, the method comprising circulating the oil-based drilling fluid of the present disclosure through the wellbore when drilling (e.g., when drilling the well to depth).

The preceding general areas of utility are given by way of example only and are not intended to be limiting on the scope of the present disclosure and appended claims. Additional objects and advantages associated with the polymers, compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### DETAILED DESCRIPTION

The inventors of the present disclosure have surprisingly and unexpected discovered that by using a non-traditional fatty acid composition comprised of saturated fatty acids and C₁₆₋₁₈ fatty acids, instead of tall oil fatty acids (TOFA), melting temperature of the subsequent emulsifier (e.g., secondary emulsifier) can be increased such that the emulsifier is a solid well above room temperature (e.g., about 20° C. to about 22° C.), thereby reducing the tackiness of the emulsifier, allows for emulsifier solid to be mechanically broken (e.g. flake, grind, etc.) into particulate matter (e.g., flakes, pellets, powder, etc.), and allows the emulsifier to be stored without significant blocking effects on the bulk powder. Thus, the present disclosure provides a solid secondary emulsifier that does not require spray drying or solid supports/support material, and solidifies from the reaction melt. Furthermore, no processing solvent is required (e.g., or utilized) during the manufacture of the emulsifier of the present disclosure. Additionally, the emulsifier of the present disclosure does not require the use of other additives (e.g., one or more of a solvent, a diluent, an absorbent, a pour point depressant, etc.) to make a workable, final product. With appropriate solids processing, as described herein, the emulsifier of the present disclosure is a pourable powder. The solid emulsifier of the present disclosure maintains its form as a free-flowing particulate/powder, thereby decreasing the amount of processing required. Thus, the emulsifiers of the present disclosure result in amidoamine reaction product concentrations that are not obtainable with (i) commercially available solid products, which includes up to 40% adsorbent/solid support, or (ii) commercially available liquid products, which include 20-40% diluent/pour point depressant to have a pourable viscosity.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended (that is, to mean including but not limited to). It is expressly contemplated that all embodiments, and claims reciting one of the open-ended transitional phrases can be written with any other transitional phrase, which may be more limiting, unless clearly precluded by the context or art. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “effective” is used to describe an amount of a compound, composition or component which, when used within the context of its intended use, effects an intended result. The term effective subsumes all other effective amount or effective concentration terms, which are otherwise described or used in the present application.

### Emulsifier and Methods of Making the Same

As discussed herein, the inventors of the present disclosure surprisingly and unexpected discovered that by using a non-traditional fatty acid composition, the melting temperature of the subsequent emulsifier (e.g., secondary emulsifier) can be increased such that the emulsifier is a solid well above room temperature (e.g., about 20° C. to about 22° C.), thereby reducing the tackiness of the emulsifier, allows for emulsifier solid to be mechanically broken (e.g. flake, grind, etc.) to particulate matter (e.g., flakes, pellets, powder, etc.), and allows the emulsifier to be stored without significant blocking effects on the bulk powder. Thus, the present disclosure provides a solid emulsifier or secondary emulsifier that does not require spray drying or solid supports (such as, a silica, a diatomaceous earth, a zeolite, etc.), and solidifies from the reaction melt. The emulsifier of the present disclosure maintains its form as a free-flowing particulate/powder, thereby decreasing the amount of processing required.

Emulsifiers produced with traditional fatty acid compositions, such as tall oil fatty acids (TOFA) results in compositions that required spray drying or solid support to limit blocking effects on bulk powder forms. Even then, traditional fatty acid composition-based emulsifiers are plagued with clumping/blocking. In any aspect or embodiment described herein, the fatty acid composition does not include, or is not, distilled tall oil (DTO), tall oil fatty acids (TOFA), or a combination thereof. In any aspect or embodiment described herein, the fatty acid composition does not include, or is not, distilled tall oil (DTO). In any aspect or embodiment described herein, the fatty acid composition does not include, or is not, tall oil fatty acids (TOFA).

Tall oil fatty acids (TOFA) is produced as a byproduct of the Kraft pulping process of coniferous trees. In particular, the kraft pulping process is utilized to convert wood into wood pulp, wherein crude tall oil (CTO) is produced as a byproduct. Crude tall oil can be upgraded through distillation to produce rosin-rich distillates and distilled tall oil. Distillation streams produce tall oil pitch (TOP), tall oil rosin (TOR), head streams (light ends), tall oil fatty acids (TOFA), and distilled tall oil (DTO). Pine tree-derived TOR contains several C20 acid isomers including abietic, dehydroabietic, and pimaric acids. TOFA comprises primarily C18 linear saturated and unsaturated chains (for example, linoleic acid, oleic acid, and linolenic acid). The principle composition and yields of tall oil fractions and some empirical volatility data is provided in Table 1, and exemplary data and composition of some tall oil fatty acids are provided in Table 2.

TABLE 1
Composition and Yields of Tall Oil Fractions
and Empirical Volatility Data

| | Yield | Acid | Composition (%) | | |
|---|---|---|---|---|---|
| | (%) | Number | Rosin Acids | Fatty Acids | Neutrals |
| Head, light ends | 5-12 | 70-120 | <0.5 | 30-50 | 40-60 |
| Tall Oil | 35-45 | 192-197 | <2 | 95-98 | 1-2 |
| Fatty Acids | | | | | |
| Distilled | 5-15 | 180-190 | 20-30 | 65-70 | 4-7 |
| Tall Oil | | | | | |
| Tall Oil Rosin | 20-35 | 165-182 | 85-96 | 1-5 | 1-7 |
| Tall Oil Pitch | 20-40 | 20-50 | 5-13 | 5-10 | 40-60 |

TABLE 2
Exemplary Data and Composition of Tall Oil Fatty Acids

| | Scandinavia | United States |
|---|---|---|
| Acid Number | 195 | 197 |
| Rosin Acid (%) | 2 | 1 |
| Unsaponifiables (%) | 2 | 1.5 |
| Iodine Value | 150 | 130 |
| Color, Garner | 4 | 3 |
| Fatty Acids (%) | | |
| Saturated | 2 | 2 |
| Oleic (18:1) | 30 | 48 |
| Linoleic (18:2) | 44 | 37 |
| Linolenic (18:3) | 10 | 3 |
| Conjugated (18:2) | 6 | 6 |
| Other | 4 | 2.5 |

Tall oil fatty acids (TOFA) is further broken down into Type I (minimum of 98% fatty acids and a maximum of 1% rosin acids), Type II (minimum of 96% fatty acids and a maximum of 2% rosin acids), and Type III (minimum of 90% fatty acids and a maximum of 10% rosin acids), as shown in Table 3, depending upon acid value, rosin acids concentration, unsaponifiables concentration, fatty acids concentration, Gardner color, and iodine value.

TABLE 3
Tall Oil Fatty Acids Requirements

| | | Type I | | Type II | | Type III | |
|---|---|---|---|---|---|---|---|
| | Method | Min | Max | Min | Max | Min | Max |
| Acid Value | ASTM D1980 | 197 | — | 192 | — | 190 | — |
| Rosin Acids (%) | ASTM D1240 | — | 1.0 | — | 2.0 | — | 10.0 |
| Unsaponifiables (%) | ASTM D1965 | — | 1.0 | — | 2.0 | — | 10.0 |
| Fatty Acids (%) | ASTM D1983 | 98 | — | 96 | — | 90 | — |
| Color, Gardner | ASTM D1544 | — | 4 | — | 5 | — | 10.0 |
| Iodine Value | ASTM D1959 | 125 | 135 | — | — | — | — |

The standard methods recited in Table 3 can be utilized to determine the acid number, rosin acid concentration (%), unsaponifiables concentration (%), fatty acids concentration (%), Gardner color, and iodine value of fatty acid compositions.

The inventors demonstrated herein that the selection of non-traditional fatty acids for the synthesis of emulsifiers (e.g., secondary emulsifiers) has a significant effect on the physical properties of the produced emulsifiers. The composition of fatty acids used is very important to the physical properties of the emulsifiers produced, thereby affecting the storage of the emulsifier, and the handling of the emulsifier, and performance of the emulsifier (e.g., performance in a drilling fluid). Changing the fatty acid composition can affect properties of the drilling fluid, including plastic viscosity, yield point, gel strengths, and viscosity at various shear rates.

An aspect of the present disclosure provides an emulsifier (or emulsifier reaction product) made by a process comprising: reacting (A) a fatty acid composition with (B) one or more (e.g., 1, 2, 3, 4, 5, 6, or more) poly(alkylamine) to produce a partial amide; and reacting (a) the partial amide with (b) an acid and/or anhydride composition that includes, consists essentially of, or consists of a dicarboxylic acid, a di-anhydride, a tricarboxylic acid, a tri-anhydride, or a mixture thereof, to produce the emulsifier, wherein the fatty acid composition comprises, consists essentially of, or consists of at least about 60% C₁₆₋₁₈ fatty acids and at least 65% saturated fatty acids (e.g., at least 85% saturated fatty acids).

An aspect of the present disclosure provides an emulsifier (or emulsifier reaction product) made by a process consisting essentially of: reacting (A) a fatty acid composition with (B) one or more (e.g., 1, 2, 3, 4, 5, 6, or more) poly(alkylamine) to produce a partial amide; and reacting (a) the partial amide with (b) an acid and/or anhydride composition that includes, consists essentially of, or consists of a dicarboxylic acid, a di-anhydride, a tricarboxylic acid, a tri-anhydride, or a mixture thereof, to produce the emulsifier, wherein the fatty acid composition comprises, consists essentially of, or consists of at least about 60% C₁₆₋₁₈ fatty acids and at least 65% saturated fatty acids (e.g., at least 85% saturated fatty acids).

An aspect of the present disclosure provides an emulsifier (or emulsifier reaction product) made by a process consisting of: reacting (A) a fatty acid composition with (B) one or more (e.g., 1, 2, 3, 4, 5, 6, or more) poly(alkylamine) to produce a partial amide; and reacting (a) the partial amide with (b) an acid and/or anhydride composition that includes, consists essentially of, or consists of a dicarboxylic acid, a di-anhydride, a tricarboxylic acid, a tri-anhydride, or a mixture thereof, to produce the emulsifier, wherein the fatty acid composition comprises, consists essentially of, or consists of at least about 60% C₁₆₋₁₈ fatty acids and at least 65% saturated fatty acids (e.g., at least 85% saturated fatty acids).

In any aspect or embodiment described herein, the emulsifier is an emulsifier reaction product.

In any aspect or embodiment described herein, the emulsifier does not include a support material or a solid support (e.g., a silica, a diatomaceous earth, a zeolite, etc.). In any aspect or embodiment described herein, the emulsifier does not include an absorbent. In any aspect or embodiment described herein, the emulsifier does not include any additives (e.g., one or more of a solvent, a diluent, an absorbent, a pour point depressant, a silica, a diatomaceous earth, a zeolite, etc.). In any aspect or embodiment described herein, the process or method described herein does not include spray drying the emulsifier. In any aspect or embodiment described herein, the emulsifier is not spray dried. In any aspect or embodiment described herein, the emulsifier only includes the emulsifier reaction product formed from the fatty acid composition, the one or more poly(alkylamine), and the acid and/or anhydride composition, as described herein. In any aspect or embodiment described herein, the emulsifier consists of the emulsifier reaction product formed from the fatty acid composition, the one or more poly(alkylamine), and the acid and/or anhydride composition, as described herein. In any aspect or embodiment described herein, the emulsifier is entirely (i.e., 100%) the reaction product formed from the fatty acid composition, the one or more poly(alkylamine), and the acid and/or anhydride composition, as described herein. In any aspect or embodiment described herein, the emulsifier does not include any additional materials than the reaction product formed from the fatty acid composition, the one or more poly(alkylamine), and the acid and/or anhydride composition, as described herein.

A further aspect of the present disclosure provides a method of making an emulsifier (or emulsifier reaction product) of the present disclosure. In any aspect or embodiment described herein, the method comprises: reacting (A) a fatty acid composition with (B) one or more (e.g., 1, 2, 3, 4, 5, 6, or more) poly(alkylamine) to produce a partial amide; and reacting (a) the partial amide with (b) an acid and/or anhydride composition that includes, consists essentially of, or consists of a dicarboxylic acid, a di-anhydride, a tricarboxylic acid, a tri-anhydride, or a mixture thereof, to produce the emulsifier, wherein the fatty acid composition comprises, consists essentially of, or consists of at least about 60% C₁₆₋₁₈ fatty acids and at least 65% saturated fatty acids (e.g., at least 85% saturated fatty acids). In any aspect or embodiment described herein, the method consists essentially of: reacting (A) a fatty acid composition with (B) one or more (e.g., 1, 2, 3, 4, 5, 6, or more) poly(alkylamine) to produce a partial amide; and reacting (a) the partial amide with (b) an acid and/or anhydride composition that includes, consists essentially of, or consists of a dicarboxylic acid, a di-anhydride, a tricarboxylic acid, a tri-anhydride, or a mixture thereof, to produce the emulsifier, wherein the fatty acid composition comprises, consists essentially of, or consists of at least about 60% C₁₆₋₁₈ fatty acids and at least 65% saturated fatty acids (e.g., at least 85% saturated fatty acids). In any aspect or embodiment described herein, the method consists of: reacting (A) a fatty acid composition with (B) one or more (e.g., 1, 2, 3, 4, 5, 6, or more) poly(alkylamine) to produce a partial amide; and reacting (a) the partial amide with (b) an acid and/or anhydride composition that includes, consists essentially of, or consists of a dicarboxylic acid, a di-anhydride, a tricarboxylic acid, a tri-anhydride, or a mixture thereof, to produce the emulsifier, wherein the fatty acid composition comprises, consists essentially of, or consists of at least about 60% C₁₆₋₁₈ fatty acids and at least 65% saturated fatty acids (e.g., at least 85% saturated fatty acids).

In any aspect or embodiment described herein, (i) the emulsifier does not include a support material, a solid support, a solvent, a diluent, an adsorbent, a pour point depressant, any additives, or a combination thereof; (ii) the emulsifier only includes the emulsifier reaction product; (iii) the emulsifier consists of the emulsifier reaction product; or (iv) a combination thereof. In any aspect or embodiment described herein, the emulsifier does not include a support material, a solid support, a solvent, a diluent, an adsorbent, a pour point depressant, any additives, or a combination thereof. In any aspect or embodiment described herein, the emulsifier only includes the emulsifier reaction product. In any aspect or embodiment described herein, the emulsifier consists of the emulsifier reaction product.

In any aspect or embodiment described herein, the fatty acid composition comprises, consists essentially of, or consists of at least about 60%, at least about 65%, at least about 70%, at least about 75%, at least about 80%, at least about 85%, at least about 90%, at least about 95%, at least about 98%, at least about 99%, or 100% C₁₆₋₁₈ fatty acids.

In any aspect or embodiment described herein, the fatty acid composition comprises, consists essentially or, or consists of at least about 65%, at least about 70%, at least about 75%, at least about 80%, at least about 85%, at least about 90%, at least about 95%, at least about 98%, at least about 99%, or 100% saturated fatty acids (e.g., at least 85% saturated fatty acids).

In any aspect or embodiment described herein, the fatty acid composition comprises one or more (e.g., 1, 2, 3, 4, 5, 6, 7, 8, 9, 10, or more) C₁₆₋₁₈ fatty acid (e.g., a mixture of C₁₆₋₁₈ fatty acids or AltaVeg™ FA 450). In any aspect or embodiment described herein, the fatty acid composition consists essentially of one or more (e.g., 1, 2, 3, 4, 5, 6, 7, 8, 9, 10, or more) C₁₆₋₁₈ fatty acid (e.g., a mixture of C₁₆₋₁₈ fatty acids or AltaVeg™ FA 450). In any aspect or embodiment described herein, the fatty acid composition consists of one or more (e.g., 1, 2, 3, 4, 5, 6, 7, 8, 9, 10, or more) C₁₆₋₁₈ fatty acid (e.g., a mixture of C₁₆₋₁₈ fatty acids or AltaVeg™ FA 450). In any aspect or embodiment described herein, the fatty acid composition includes, consists essentially of, or consists of palmitic acid, stearic acid, hydrogenated tallow fatty acids, or a mixture thereof. AltaVeg™ FA 450 contains about 70% palmitic acid, <5% stearic acid, and the remainder being unsaturated C₁₈ fatty acids. In any aspect or embodiment described herein, the fatty acid composition comprises, consists essentially of, or consists of: at least about 60% C₁₆ fatty acids (e.g., palmitic acid) and C₁₈ fatty acids (e.g., stearic acid); less than about 13% C₁₈ fatty acids (e.g., stearic acid); less than about 30% unsaturated C₁₈ fatty acids; or a combination thereof. In any aspect or embodiment described herein, the fatty acid composition comprises, consists essentially of, or consists of: at least about 65% C₁₆ fatty acids (e.g., palmitic acid) and C₁₈ fatty acids (e.g., stearic acid); less than about 10% C₁₈ fatty acids (e.g., stearic acid); less than about 25% unsaturated C₁₈ fatty acids; or a combination thereof. In any aspect or embodiment described herein, the fatty acid composition includes, consists essentially of, or consists of: at least about 65% C₁₆ fatty acids (e.g., palmitic acid) and C₁₈ fatty acids (e.g., stearic acid), less than about 10% C₁₈ fatty acids (e.g., stearic acid), and less than about 25% unsaturated C₁₈ fatty acids. In any aspect or embodiment described herein, the fatty acid composition comprises, consists essentially of, or consists of about 70% palmitic acid, <5% stearic acid, and the balance is unsaturated C₁₈ fatty acids.

In any aspect or embodiment described herein, the fatty acid composition comprises, consists essentially of, or consists of at least about 60%, at least about 65%, at least about 70%, at least about 75%, at least about 80%, at least about 85%, at least about 90%, at least about 95%, at least about 98%, at least about 99%, or 100% of a mixture of C₁₆ fatty acids (e.g., palmitic acid) and C₁₈ fatty acids (e.g., stearic acid).

In any aspect or embodiment described herein, the fatty acid composition comprises, consists essentially of, or consists of at least about 60%, at least about 65%, at least about 70%, at least about 75%, at least about 80%, at least about 85%, at least about 90%, at least about 95%, at least about 98%, at least about 99%, or 100% of a mixture of saturated C₁₆ fatty acids (e.g., palmitic acid) and saturated C₁₈ fatty acids (e.g., stearic acid).

In any aspect or embodiment described herein, the fatty acid composition comprises, consists essentially of, or consists of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99%, or 100% C₁₆ fatty acids (e.g., palmitic acid).

In any aspect or embodiment described herein, the fatty acid composition comprises, consists essentially of, or consists of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99%, or 100% saturated C₁₆ fatty acids (e.g., palmitic acid).

In any aspect or embodiment described herein, the fatty acid composition comprises, consists essentially of, or consists of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99%, or 100% C₁₈ fatty acids (e.g., stearic acid).

In any aspect or embodiment described herein, the fatty acid composition comprises, consists essentially of, or consists of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99%, or 100% saturated C₁₈ fatty acids (e.g., stearic acid).

In any aspect or embodiment described herein, the fatty acid composition comprises, consists essentially of, or consists of less than about 30%, less than about 29%, less than about 28%, less than about 27%, less than about 26%, less than about 25%, less than about 24%, less than about 23%, less than about 22%, less than about 21%, less than about 20%, less than about 19%, less than about 18%, less than about 17%, less than about 16%, less than about 15%, less than about 14%, less than about 13%, less than about 12%, less than about 11%, less than about 10%, less than about 9%, less than about 8%, less than about 7%, less than about 6%, less than about 5%, less than about 4%, less than about 3%, less than about 2%, less than about 1%, or 0% unsaturated fatty acids.

In any aspect or embodiment described herein, the fatty acid composition comprises, consists essentially of, or consists of less than about 30%, less than about 29%, less than about 28%, less than about 27%, less than about 26%, less than about 25%, less than about 24%, less than about 23%, less than about 22%, less than about 21%, less than about 20%, less than about 19%, less than about 18%, less than about 17%, less than about 16%, less than about 15%, less than about 14%, less than about 13%, less than about 12%, less than about 11%, less than about 10%, less than about 9%, less than about 8%, less than about 7%, less than about 6%, less than about 5%, less than about 4%, less than about 3%, less than about 2%, less than about 1%, or 0% unsaturated C₁₈ fatty acids.

In any aspect or embodiment described herein, the poly(alkylamine) includes 1 to 12 carbon atoms (e.g., 3 to 9 or 4 to 8 carbon atoms), 1 to 7 nitrogen atoms (e.g., 2 to 6 or 3 to 5 nitrogen atoms), or a combination thereof (e.g., 1 to 12 carbon atoms and 1 to 7 nitrogen atoms, 4 to 8 carbon atoms and 3 to 5 nitrogen atoms, or 3 to 9 carbon atoms and 2 to 6 nitrogen atoms). For example, in any aspect or embodiment described herein, the poly(alkamine) includes 1, 2, 3, 4, 5, 6, 7, 8, 9, 10, 11, or 12 carbon atoms. In any aspect or embodiment described herein, the poly(alkylamine) includes 1, 2, 3, 4, 5, 6, or 7 nitrogen atoms.

In any aspect or embodiment described herein, the one or more poly(alkylamine) includes, consists essentially of, or consists of diethylenetriamine (DETA), triethylenetetramine (TETA), tetraethylenepentamine (TEPA), or a mixture thereof. In any aspect or embodiment described herein, the one or more poly(alkylamine) includes, consists essentially of, or consists of diethylenetriamine (DETA).

In any aspect or embodiment described herein, the dicarboxylic acid includes, consists essentially of, or consists of a C₂₋₆ dicarboxylic acid (e.g., maleic acid, fumaric acid, succinic acid, or a mixture thereof). For example, in any aspect or embodiment described herein, the dicarboxylic acid includes, consists essentially of, or consists of maleic acid, fumaric acid, succinic acid, or a mixture thereof. In any aspect or embodiment described herein, the dicarboxylic acid comprises, consists essentially of, or consists of a C₂, C₃, C₄, C₅, or C₆ dicarboxylic acid.

In any aspect or embodiment described herein, the di-anhydride comprises, consists essentially of, or consists of a C₂₋₆ di-anhydride (e.g. maleic anhydride, succinic anhydride, or a mixture thereof). For example, in any aspect or embodiment described herein, the di-anhydride includes, consists essentially of, or consists of maleic anhydride, succinic anhydride, or a mixture thereof. In any aspect or embodiment described herein, the di-anhydride includes, consists essentially of, or consists of a C₂, C₃, C₄, C₅, or C₆ di-anhydride.

In any aspect or embodiment described herein, the tricarboxylic acid includes, consists essentially of, or consists of a C₃₋₈ tricarboxylic acid. For example, in any aspect or embodiment described herein, the tricarboxylic acid includes, consists essentially of, or consists of a C₃, C₄, C₅, C₆, C₇, or C₈, tricarboxylic acid.

In any aspect or embodiment described herein, the tri-anhydride includes, consists essentially of, or consists of a C₃₋₈ tri-anhydride. For example, in any aspect or embodiment described herein, the tricarboxylic acid includes, consists essentially of, or consists of a C₃, C₄, C₅, C₆, C₇, or C₈ tri-anhydride.

In any aspect or embodiment described herein, the acid and/or anhydride composition includes, consists essentially of, or consists of maleic acid, fumaric acid, succinic acid, succinic anhydride, maleic anhydride, or a mixture thereof. In any aspect or embodiment described herein, the acid and/or anhydride composition or the di-anhydride includes, consists essentially of, or consists of maleic anhydride.

In any aspect or embodiment described herein, the fatty acid composition is present in an amount of about 75 to about 90 wt % (e.g., about 78 to about 88 wt %) of the partial amide. For example, in any aspect or embodiment described herein, the fatty acid composition is present in an amount of about 75 to about 90 wt %, about 75 to about 85 wt %, about 75 to about 80 wt %, about 80 to about 90 wt %, about 80 to about 85 wt %, or about 85 to about 90 wt % of the partial amide. In any aspect or embodiment described herein, the fatty acid composition is present in an amount of about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, any values in between, or a range from any combination of the values, of the partial amide.

In any aspect or embodiment described herein, the one or more poly(alkylamine) is present in an amount of about 10 to about 25 wt % (e.g., about 12 to about 22 wt %) of the partial amide. For example, in any aspect or embodiment described herein, the one or more poly(alkylamine) is present in an amount of about 10 to about 25 wt %, about 10 to about 22.5 wt %, about 10 to about 20 wt %, about 10 to about 17.5 wt %, about 10 to about 15 wt %, about 10 to about 12.5 wt %, about 12.5 to about 25 wt %, about 12.5 to about 22.5 wt %, about 12.5 to about 20 wt %, about 12.5 to about 17.5 wt %, about 12.5 to about 15 wt %, about 15 to about 25 wt %, about 15 to about 22.5 wt %, about 15 to about 20 wt %, about 15 to about 17.5 wt %, about 17.5 to about 25 wt %, about 17.5 to about 22.5 wt %, about 17.5 to about 20 wt %, about 20 to about 25 wt %, about 20 to about 22.5 wt %, or about 22.5 to about 25 wt % of the partial amide. In any aspect or embodiment described herein, the one or more poly(alkylamine) is present in an amount of about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, any values in between, or a range from any combination of the values, of the partial amide.

In any aspect or embodiment described herein, the partial amide is present in an amount of about 80 to about 95 wt % (e.g., about 85 to about 95 wt % or about 90 wt %) of the emulsifier. For example, in any aspect or embodiment described herein, the partial amide is present in an amount of about 80 to about 95 wt %, about 80 to about 90 wt %, about 80 to about 85 wt %, about 85 to about 95 wt %, about 85 to about 90 wt %, or about 90 to about 95 wt % of the emulsifier. In any aspect or embodiment described herein, the partial amide is present in an amount of about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, any values in between, or a range from any combination of the values, of the emulsifier.

In any aspect or embodiment described herein, the acid and/or anhydride composition is present in an amount of about 5 to about 20 wt % (e.g., about 5 to about 15 wt % or about 10 wt %) of the emulsifier. For example, in any aspect or embodiment described herein, the acid and/or anhydride composition is present in an amount of about 5 to about 17.5 wt %, about 5 to about 15 wt %, about 5 to about 12.5 wt %, about 5 to about 10 wt %, about 5 to about 7.5 wt %, about 7.5 to about 17.5 wt %, about 7.5 to about 15 wt %, about 7.5 to about 12.5 wt %, about 7.5 to about 10 wt %, about 10 to about 17.5 wt %, about 10 to about 15 wt %, about 10 to about 12.5 wt %, about 12.5 to about 17.5 wt %, about 12.5 to about 15 wt %, about 15 to about 20 wt %, about 15 to about 17.5 wt %, or about 17.5 to about 20 wt % of the emulsifier. For example, in any aspect or embodiment described herein, the acid and/or anhydride composition is present in an amount of about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, any values in between, or a range from any combination of the values, of the emulsifier.

In any aspect or embodiment described herein, the molar ratio of the fatty acid composition to the poly(alkylamine) is about 1.85 to about 2.0. For example, in any aspect or embodiment described herein, the molar ratio of the fatty acid composition to the poly(alkylamine) is about 1.85 to about 2.0, about 1.86 to about 2.0, about 1.87 to about 2.0, about 1.88 to about 2.0, about 1.89 to about 2.0, 1.90 to about 2.0, 1.91 to about 2.0, 1.92 to about 2.0, 1.93 to about 2.0, 1.94 to about 2.0, about 1.95 to about 2.0, 1.96 to about 2.0, 1.97 to about 2.0, 1.98 to about 2.0, or 1.91 to about 2.0.

In any aspect or embodiment described herein, the molar ratio of the partial amide to the acid and/or anhydride composition is about 0.6 to about 1.0 (e.g., about 0.6 to about 0.75). For example, in any aspect or embodiment described herein, the molar ratio of the partial amide to the acid and/or anhydride composition is about 0.6 to about 1.0, about 0.7 to about 1.0, about 0.8 to about 1.0, or about 0.9 to about 1.0.

In any aspect or embodiment described herein, the emulsifier has an acid number of about 45 to about 80. For example, in any aspect or embodiment described herein, the emulsifier has an acid number of about 45 to about 80, about 45 to about 75, about 45 to about 70, about 45 to about 65, about 45 to about 60, about 45 to about 55, about 45 to about 50, about 50 to about 80, about 50 to about 75, about 50 to about 70, about 50 to about 65, about 50 to about 60, about 50 to about 55, about 55 to about 80, about 55 to about 75, about 55 to about 70, about 55 to about 65, about 55 to about 60, about 60 to about 80, about 60 to about 75, about 60 to about 70, about 60 to about 65, about 65 to about 80, about 65 to about 75, about 65 to about 70, about 70 to about 80, about 70 to about 75, or about 75 to about 80. In any aspect or embodiment described herein, the emulsifier has an acid number of about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, any values in between, or a range from any combination of the values.

In any aspect or embodiment described herein, the emulsifier has an amine number of about 5 to about 15. For example, in any aspect or embodiment described herein, the emulsifier has an amine number of about 5, about 6, about 7, about 8, about 9, about 10, about 11, about 12, about 13, about 14, about 15, any values in between, or a range from any combination of the values.

In any aspect or embodiment described herein, reacting the fatty acid composition with the poly(alkylamine) comprises or consists essentially of heating the fatty acid composition (e.g., heating the fatty acid composition to the melting point of the fatty acid composition, such as about 50° C. to about 100° C.) to produce a molten fatty acid composition. In any aspect or embodiment described herein, reacting the fatty acid composition with the poly(alkylamine) comprises or consists essentially of heating the fatty acid composition to the melting point of the fatty acid composition. For example, in any aspect or embodiment described here, reacting the fatty acid composition with the poly(alkylamine) comprises or consists essentially of heating the fatty acid composition to about 50° C. to about 100° C., about 50° C. to about 95° C., about 50° C. to about 90° C., about 50° C. to about 85° C., about 50° C. to about 80° C., about 50° C. to about 75° C., about 50° C. to about 70° C., about 50° C. to about 65° C., about 50° C. to about 60° C., about 55° C. to about 100° C., about 55° C. to about 95° C., about 55° C. to about 90° C., about 55° C. to about 85° C., about 55° C. to about 80° C., about 55° C. to about 75° C., about 55° C. to about 70° C., about 55° C. to about 65° C., about 60° C. to about 100° C., about 60° C. to about 95° C., about 60° C. to about 90° C., about 60° C. to about 85° C., about 60° C. to about 80° C., about 60° C. to about 75° C., about 60° C. to about 70° C., about 65° C. to about 100° C., about 65° C. to about 95° C., about 65° C. to about 90° C., about 65° C. to about 85° C., about 65° C. to about 80° C., about 65° C. to about 75° C., about 70° C. to about 100° C., about 70° C. to about 95° C., about 70° C. to about 90° C., about 70° C. to about 85° C., about 70° C. to about 80° C., about 75° C. to about 100° C., about 75° C. to about 95° C., about 75° C. to about 90° C., about 75° C. to about 85° C., about 80° C. to about 100° C., about 80° C. to about 95° C., about 80° C. to about 90° C., about 85° C. to about 100° C., about 85° C. to about 95° C., about 90° C. to about 100° C.

In any aspect or embodiment described herein, reacting the fatty acid composition with the poly(alkylamine) comprises or consists essentially of adding the acid and/or anhydride composition to the fatty acid composition (e.g., a molten fatty acid composition). For example, in any aspect or embodiment described herein, reacting the fatty acid composition with the poly(alkylamine) comprises or consists essentially of adding the acid and/or anhydride composition to a molten fatty acid composition.

In any aspect or embodiment described herein, reacting the fatty acid composition with the poly(alkylamine) comprises or consists essentially of agitating the fatty acid composition and the one or more poly(alkylamine) reaction mixture.

In any aspect or embodiment described herein, reacting the fatty acid composition with the poly(alkylamine) comprises or consists essentially of reacting the fatty acid composition and the acid and/or anhydride composition at about 145° C. to about 185° C. (e.g., about 150° C. to about 180° C. or about 150° C. to about 170° C.) until the acid number (AN) is less than about 20 mg/g, less than about 15 mg/g, or less than about 10 mg/g. For example, in any aspect or embodiment described herein, In any aspect or embodiment described herein, reacting the fatty acid composition with the poly(alkylamine) comprises or consists essentially of reacting the fatty acid composition and the acid and/or anhydride composition at about 145° C. to about 185° C. (e.g., about 150° C. to about 180° C. or about 150° C. to about 170° C.). For example, in any aspect or embodiment described herein, reacting the fatty acid composition with the poly(alkylamine) comprises or consists essentially of reacting the fatty acid composition and the acid and/or anhydride composition at about 145° C. to about 185° C., about 145° C. to about 180° C., about 145° C. to about 175° C., about 145° C. to about 170° C., about 145° C. to about 165° C., about 145° C. to about 160° C., about 145° C. to about 155° C., about 150° C. to about 185° C., about 150° C. to about 180° C., about 150° C. to about 175° C., about 150° C. to about 170° C., about 150° C. to about 165° C., about 150° C. to about 160° C., about 155° C. to about 185° C., about 155° C. to about 180° C., about 155° C. to about 175° C., about 155° C. to about 170° C., about 155° C. to about 165° C., about 160° C. to about 185° C., about 160° C. to about 180° C., about 160° C. to about 175° C., about 160° C. to about 170° C., about 165° C. to about 185° C., about 165° C. to about 180° C., about 165° C. to about 175° C., about 170° C. to about 185° C., about 170° C. to about 180° C., or about 175° C. to about 185° C. In any aspect or embodiment described herein, reacting the fatty acid composition with the poly(alkylamine) comprises or consists essentially of reacting the fatty acid composition and the acid and/or anhydride composition until the acid number (AN) is less than about 20 mg/g, less than about 19 mg/g, less than about 18 mg/g, less than about 17 mg/g, less than about 16 mg/g, less than about 15 mg/g, less than about 14 mg/g, less than about 13 mg/g, less than about 12 mg/g, less than about 11 mg/g, or less than about 10 mg/g. For example, in any aspect or embodiment described herein, reacting the fatty acid composition with the poly(alkylamine) comprises or consists essentially of reacting the fatty acid composition and the acid and/or anhydride composition until the acid number (AN) is about 20 mg/g to about 10 mg/g.

In any aspect or embodiment described herein, reacting the fatty acid composition with the poly(alkylamine) comprises or consists essentially of reacting the fatty acid composition and the acid and/or anhydride composition for about 30 minutes to about 3 hours or about 1 hour to about 2.5 hours. For example, in any aspect or embodiment described herein, reacting the fatty acid composition with the poly(alkylamine) comprises or consists essentially of reacting the fatty acid composition and the acid and/or anhydride composition for about 30 to about 180 minutes, about 30 to about 165 minutes, about 30 to about 150 minutes, about 30 to about 135 minutes, about 30 to about 120 minutes, about 30 to about 105 minutes, about 30 to about 90 minutes, about 30 to about 75 minutes, about 30 to about 60 minutes, about 30 to about 45 minutes, about 45 to about 180 minutes, about 45 to about 165 minutes, about 45 to about 150 minutes, about 45 to about 135 minutes, about 45 to about 120 minutes, about 45 to about 105 minutes, about 45 to about 90 minutes, about 45 to about 75 minutes, about 45 to about 60 minutes, about 60 to about 180 minutes, about 60 to about 165 minutes, about 60 to about 150 minutes, about 60 to about 135 minutes, about 60 to about 120 minutes, about 60 to about 105 minutes, about 60 to about 90 minutes, about 60 to about 75 minutes, about 75 to about 180 minutes, about 75 to about 165 minutes, about 75 to about 150 minutes, about 75 to about 135 minutes, about 75 to about 120 minutes, about 75 to about 105 minutes, about 75 to about 90 minutes, about 90 to about 180 minutes, about 90 to about 165 minutes, about 90 to about 150 minutes, about 90 to about 135 minutes, about 90 to about 120 minutes, about 90 to about 105 minutes, about 105 to about 180 minutes, about 105 to about 165 minutes, about 105 to about 150 minutes, about 105 to about 135 minutes, about 105 to about 120 minutes, about 120 to about 180 minutes, about 120 to about 165 minutes, about 120 to about 150 minutes, about 120 to about 135 minutes, about 135 to about 180 minutes, about 135 to about 165 minutes, about 135 to about 150 minutes, about 150 to about 180 minutes, about 150 to about 165 minutes, or about 165 to about 180 minutes.

In any aspect or embodiment described herein, reacting the partial amide with the acid and/or anhydride composition comprises or consists essentially of heating the partial amide to about 100° C. to about 140° C. (e.g., about 110° C. to about 130° C., or about 120° C.). For example, in any aspect or embodiment described herein, reacting the partial amide with the acid and/or anhydride composition comprises or consists essentially of heating the partial amide to about 100° C. to about 140° C., about 100° C. to about 135° C., about 100° C. to about 130° C., about 100° C. to about 125° C., about 100° C. to about 120° C., about 100° C. to about 115° C., about 100° C. to about 110° C., about 105° C. to about 140° C., about 105° C. to about 135° C., about 105° C. to about 130° C., about 105° C. to about 125° C., about 105° C. to about 120° C., about 105° C. to about 115° C., about 110° C. to about 140° C., about 110° C. to about 135° C., about 110° C. to about 130° C., about 110° C. to about 125° C., about 110° C. to about 120° C., about 115° C. to about 140° C., about 115° C. to about 135° C., about 115° C. to about 130° C., about 115° C. to about 125° C., about 120° C. to about 140° C., about 120° C. to about 135° C., about 120° C. to about 130° C., about 125° C. to about 140° C., about 125° C. to about 135° C., or about 130° C. to about 140° C.

In any aspect or embodiment described herein, reacting the partial amide with the acid and/or anhydride composition comprises or consists essentially of adding the acid and/or anhydride composition to the partial amide. For example, in any aspect or embodiment described herein, reacting the partial amide with the acid and/or anhydride composition comprises or consists essentially of adding the acid and/or anhydride composition while maintaining the temperature of the mixture below about 140° C. (e.g., about 120° C. to about 130° C.), about 140° C., about 139° C., about 138° C., about 137° C., about 136° C., about 135° C., about 134° C., about 133° C., about 132° C., about 131° C., about 130° C., about 129° C., about 128° C., about 127° C., about 126° C., about 125° C., about 124° C., about 123° C., about 122° C., about 121° C., about 120° C., about 119° C., about 118° C., about 117° C., about 116° C., about 115° C., any values in between, or a range from any combination of the values, during the addition.

In any aspect or embodiment described herein, reacting the partial amide with the acid and/or anhydride composition comprises or consists essentially of agitating the partial amide and the acid and/or anhydride composition reaction mixture.

In any aspect or embodiment described herein, reacting the partial amide with the acid and/or anhydride composition comprises or consists essentially of reacting the partial amide and the acid and/or anhydride composition at about 130° C. to about 165° C. (e.g., about 130° C. to about 150° C. or about 130° C. to about 140° C.). For example, in any aspect or embodiment described herein, reacting the partial amide with the acid and/or anhydride composition comprises or consists essentially of reacting the partial amide and the acid and/or anhydride composition at about 130° C. to about 165° C., about 130° C. to about 160° C., about 130° C. to about 155° C., about 130° C. to about 150° C., about 130° C. to about 145° C., about 130° C. to about 140° C., about 135° C. to about 165° C., about 135° C. to about 160° C., about 135° C. to about 155° C., about 135° C. to about 150° C., about 135° C. to about 145° C., about 140° C. to about 165° C., about 140° C. to about 160° C., about 140° C. to about 155° C., about 140° C. to about 150° C., about 145° C. to about 165° C., about 145° C. to about 160° C., about 145° C. to about 155° C., about 150° C. to about 165° C., about 150° C. to about 160° C., about 150° C. to about 160° C.

In any aspect or embodiment described herein, reacting the partial amide with the acid and/or anhydride composition comprises or consists essentially of reacting the partial amide and the acid and/or anhydride composition for about 30 minutes to about 90 minutes (e.g., about 30 minutes to about 75 minutes, about 45 minutes to about 60 minutes, or about 45 minutes). For example, in any aspect or embodiment described herein, reacting the partial amide with the acid and/or anhydride composition comprises or consists essentially of reacting the partial amide and the acid and/or anhydride composition for about 30 minutes to about 90 minutes, about 30 minutes to about 80 minutes, about 30 minutes to about 70 minutes, about 30 minutes to about 60 minutes, about 30 minutes to about 50 minutes, about 30 minutes to about 40 minutes, about 40 minutes to about 90 minutes, about 40 minutes to about 80 minutes, about 40 minutes to about 70 minutes, about 40 minutes to about 60 minutes, about 40 minutes to about 50 minutes, about 50 minutes to about 90 minutes, about 50 minutes to about 80 minutes, about 50 minutes to about 70 minutes, about 50 minutes to about 60 minutes, about 60 minutes to about 90 minutes, about 60 minutes to about 80 minutes, about 60 minutes to about 70 minutes, about 70 minutes to about 90 minutes, about 70 minutes to about 80 minutes, or about 80 minutes to about 90 minutes.

In any aspect or embodiment described herein, reacting the partial amide with the acid and/or anhydride composition comprises or consists essentially of reacting the partial amide and the acid and/or anhydride composition until the acid number (AN) is about 45 to about 80. For example, in any aspect or embodiment described herein, reacting the partial amide with the acid and/or anhydride composition comprises or consists essentially of reacting the partial amide and the acid and/or anhydride composition until the acid number (AN) is about 45 to about 80, about 45 to about 75, about 45 to about 70, about 45 to about 65, about 45 to about 60, about 45 to about 55, about 45 to about 40, about 50 to about 80, about 50 to about 75, about 50 to about 70, about 50 to about 65, about 50 to about 60, about 50 to about 55, about 55 to about 80, about 55 to about 75, about 55 to about 70, about 55 to about 65, about 55 to about 60, about 60 to about 80, about 60 to about 75, about 60 to about 70, about 60 to about 65, about 65 to about 80, about 65 to about 75, about 65 to about 70, about 70 to about 80, about 70 to about 75, or about 75 to about 80.

In any aspect or embodiment described herein, reacting the partial amide with the acid and/or anhydride composition comprises or consists essentially of reacting the partial amide and the acid and/or anhydride composition until the amine value (AV) is about 5 to about 15. For example, in any aspect or embodiment described herein, reacting the partial amide with the acid and/or anhydride composition comprises or consists essentially of reacting the partial amide and the acid and/or anhydride composition until the amine value (AV) is about 5, about 6, about 7, about 8, about 9, about 10, about 11, about 12, about 13, about 14, about 15, any values in between, or a range from any combination of the values.

In any aspect or embodiment described herein, the process or method further comprises or consists essentially of cooling the emulsifier (e.g., about 18° C. to about 25° C.). For example, in any aspect or embodiment described herein, the process or method further comprising or consists essentially of cooling the emulsifier until it is solid. In any aspect or embodiment described herein, the process or method further comprises cooling the emulsifier to room temperature (e.g., about 20° C. to about 22° C.).

In any aspect or embodiment described herein, the emulsifier is a solid.

In any aspect or embodiment described herein, the process or method further comprises or consists essentially of mechanically breaking the emulsifier solid to a particulate (e.g., emulsifier flakes, pellets, or powder). For example, in any aspect or embodiment described herein, the emulsifier is processed to be a particulate. In any aspect or embodiment described herein, processing to be a particulate or mechanically breaking includes or consists essentially of, but not limited to, grinding or crushing. In any aspect or embodiment described herein, the emulsifier is a particulate emulsifier (e.g., flakes, pellets, or powder).

### Oil-Based Drilling Fluid and Methods of Using Oil-Based Drilling Fluid

Another aspect of the present disclosure provides an oil-based drilling fluid or mud comprising an invert emulsion of a hygroscopic liquid (e.g., a brine, such as CaCl₂ brine), one or more (e.g., 1, 2, 3, 4, 5, 6, 7, 8, or more) emulsifier, and at least one of: an oil, a mineral oil, a synthetic oil, or a combination thereof, wherein the one or more emulsifier includes, consists essentially of, or consists of the emulsifier of the present disclosure, an emulsifier produced according to the method of the present disclosure, or a combination thereof. In any aspect or embodiment described herein, the synthetic oil includes, consists essentially of, or consists of an internal olefin, a poly alpha olefin, a linear paraffin, or a combination thereof. A further aspect of the present disclosure provides an oil-based drilling fluid or mud consisting essentially of an invert emulsion of a hygroscopic liquid (e.g., a brine, such as CaCl₂ brine), one or more (e.g., 1, 2, 3, 4, 5, 6, 7, 8, or more) emulsifier, and at least one of: an oil, a mineral oil, a synthetic oil, or a combination thereof, wherein the one or more emulsifiers includes, consists essentially of, or consists of the emulsifier of the present disclosure, an emulsifier produced according to the method of the present disclosure, or a combination thereof. In any aspect or embodiment described herein, the synthetic oil includes, consists essentially of, or consists of an internal olefin, a poly alpha olefin, a linear paraffin, or a combination thereof. An additional aspect of the present disclosure provides an oil-based drilling fluid or mud consisting of, an invert emulsion of a hygroscopic liquid (e.g., a brine, such as CaCl₂ brine), one or more (e.g., 1, 2, 3, 4, 5, 6, 7, 8, or more) emulsifier, and at least one of: an oil, a mineral oil, a synthetic oil, or a combination thereof, wherein the one or more emulsifiers includes, consists essentially of, or consists of the emulsifier of the present disclosure, an emulsifier produced according to the method of the present disclosure, or a combination thereof. In any aspect or embodiment described herein, the synthetic oil includes, consists essentially of, or consists of or is an internal olefin, a poly alpha olefin, a linear paraffin, or a combination thereof.

In any aspect or embodiment described herein, the one or more emulsifiers includes a primary emulsifier (e.g., modified tall oil and/or modified fatty amine condensate).

In any aspect or embodiment described herein, the oil is diesel.

In any aspect or embodiment described herein, the hygroscopic liquid is a CaCl₂ brine, a NaCl brine, a NaBr brine, a CaBr₂ brine, a formate brine, a potassium formate, an alcohol based hygroscopic liquid, a lower polyhydric alcohol, glycerol, or polyglycerol. In any aspect or embodiment described herein, the hygroscopic liquid is a CaCl₂ brine.

In any aspect or embodiment described herein, the drilling fluid or mud further comprises one or more weighting agent (e.g., barite).

In any aspect or embodiment described herein, the drilling fluid or mud further comprises one or more (e.g., 1, 2, 3, 4, 5, 6, 7, 8, or more) rheological modifier (e.g., a clay, an organophilic clay, a bentonite clay, an amine-treated clay, an amine-treated bentonite clay, a polyamide, a dimer diacid, or combinations thereof).

In any aspect or embodiment described herein, the drilling fluid or mud further comprises one or more alkalinity agent (e.g., lime, CaO, or Ca(OH)₂).

In any aspect or embodiment described herein, the drilling fluid or mud further comprises one or more wetting agent (e.g., a fatty imidazoline, a soya lecithin, or combinations thereof).

In any aspect or embodiment described herein, the oil-based drilling fluid or mud comprises: an invert emulsion of a hygroscopic liquid (e.g., a brine, such as a CaCl₂ brine), an oil (e.g. diesel), a mineral oil, the emulsifier of the present disclosure, and an internal olefin.

An additional aspect of the present disclosure provides a method of drilling a wellbore, the method comprising circulating the oil-based drilling fluid of the present disclosure through the wellbore when drilling.

A further aspect of the present disclosure provides a method of drilling a wellbore, the method comprising circulating the oil-based drilling fluid of the present disclosure through the wellbore when drilling the well to depth.

### EXAMPLES

### Example 1: Making the Emulsifier or Additive

By substituting TOFA for a predominantly saturated C16 or C18 fatty acid mixture, the melting point of the secondary emulsifier can be increased well above room temperature, producing a product that is solid, not tacky, and easily flaked or powdered. This variation of the chemical structure allows production of a free-flowing powder without the need for solid supports or other additives such as anti-caking agents. This also eliminates the need for intensive, high energy processing steps such as spray drying to achieve powdered materials.

AltaVeg™ FA 450 was substituted for TOFA in the formulation for a maleated amidoamine secondary emulsifier to produce a product that is solid at room temperature and easily flaked or ground. AltaVeg™ FA 450 contains about 70% palmitic acid, <5% stearic acid, and the remainder is unsaturated C₁₈ fatty acids.

Brief Description of Procedure. The reactants for this two-step process are shown below in Table 4 (reaction 1) and Table 5 (reaction 2). Briefly, in the first step, a fatty acid mixture is reacted with poly(alkylamine) to obtain a partial amide which is subsequently reacted in step 2 with maleic anhydride or other similar di-acids/anhydrides, and/or tri-acids/anhydrides to form the emulsifier or secondary emulsifier. After reaction 2, the reaction melt can be cooled on a tray or in a container to obtain the solid product. The exemplary emulsifier solid had an acid number (AN) of 52 mg/g and an amine value (AV) of 15 mg/g. This material can then be broken into flakes or crushed into powder depending on the desired form for storage and application.

Acid Number and Amine Value Determination. Two grams of the low titer fatty acid material or amine material was added to a beaker. The low titer fatty acid material was dissolved in methanol or a mixture of methanol and Toluene or isopropanol using agitation and/or heat, as required for complete dissolution. The amine material was dissolved in 75 mL of isopropanol, using agitation and/or heat, as required for complete dissolution. Acid number (AN) was determined via titration with 0.5N KOH in methanol and the amine value (AV) was determined via titration with 0.5 HCL in methanol on an 888 Titrando Autotitrator (Metrohm, Riverview, FL).

Detailed Description of Procedure. The amount of each reactant for the two-step process to make the exemplary emulsifier are shown in Table 4 (reaction 1) and Table 5 (reaction 2) below. AltaVeg™ FA450 was added to a Dean-Stark apparatus with a stirrer, a N₂ line, a condenser, and a temperature probe. After heating to 93° C. at 1° C. per minute, diethylenetriamine (DETA), triethylenetetramine (TETA), and tetraethylenepentamine (TEPA) was added to the apparatus. The mixture was heated to 160° C. over the course of an hour, and then incubated at 160° C. for an hour. A sample was examined for its acid number (AN) every 20 minutes. Once the acid number (AN) was below 20 mg/g, the reaction mixture was cooled to 70° C. Each of the exemplary partial amides shown below had an acid number (AN) of <20 mg/g at first sampling.

The reaction product from reaction 1 was heated to 120° C. with agitation. Maleic anhydride was added and the temperature maintained at 130-140° C. for 45 minutes. The acid number (AN) and amine value (AV) were determined.

TABLE 4
Formulation for partial amide of the present disclosure AltaVeg ™ Partial
Amide (PA) and Hydrogenated Tallow Fatty Acid PA

| | AltaVeg ™ | Hydrogenated Tallow |
|---|---|---|
| Composition Name | PA | Fatty Acid PA |
| AltaVeg ™ FA450 | 82.90% | |
| | [529.15 g] | |
| Hydrogenated Tall | | 83.76% |
| Fatty Acid | | [534.64 g] |
| Diethylenetriamine | 16.36% | 15.5% |
| (DETA) | [104.43 g] | [98.94 g] |
| Triethylenetetramine | 0.37% | 0.37% |
| (TETA) | [2.36 g] | [2.36 g] |
| Tetraethylenepentamine | 0.37% | 0.37% |
| (TEPA) | [2.36 g] | [2.36 g] |

TABLE 5
Formulation for an exemplary emulsifier or additive of the present
disclosure prepared from the Partial Amides from Table 4

| | | AltaVeg ™ | Hydrogenated |
|---|---|---|---|
| | | Emulsifier #2 | Tallow |
| | AltaVeg ™ | (1 equivalent of | Fatty Acid (HTFA) |
| | Emulsifier #1 | maleic anhydride) | Emulsifier |
| Partial | 89.73% | 86.08% | 87.35% |
| Amide | [525.00 g] | [525.00 g] | [525.00 g] |
| Maleic | 10.27% | 13.93% | 12.65% |
| Anhydride | [60.09 g] | [84.93 g] | [76.03 g] |

TABLE 6
Formulation for partial amide of the present disclosure
Palmitic Acid Partial Amide (PA), Stearic Acid Partial
Amide (PA), AltaVeg ™-Stearic Acid Partial Amide
(PA), and AltaVeg ™-Stearic Acid-Palmitic Acid Partial Amide (PA)

| | | | | AltaVeg ™- |
|---|---|---|---|---|
| | | | AltaVeg ™- | Stearic Acid- |
| | Palmitic | Stearic | Stearic | Palmitic |
| Composition Name | Acid PA | Acid PA | Acid PA | Acid PA |
| Palmitic Acid | 82.30% | | | 12.50% |
| | [525.32 g] | | | [106.60 g] |
| Stearic Acid | | 83.76% | 29.11% | 29.16% |
| | | [534.64 g] | [185.80 g] | [186.10 g] |
| AltaVeg ™ FA450 | | | 54.06% | 41.65% |
| | | | [345.06 g] | [265.85 g] |
| Diethylenetriamine | 16.96% | 15.5% | 16.09% | 16.70% |
| (DETA) | [108.26 g] | [98.94 g] | [102.71 g] | [106.60 g] |
| Triethylenetetramine | 0.37% | 0.37% | 0.37% | |
| (TETA) | [2.36 g] | [2.36 g] | [2.36 g] | |
| Tetraethylene- | 0.37% | 0.37% | 0.37% | |
| pentamine | [2.36 g] | [2.36 g] | [2.36 g] | |
| (TEPA) | | | | |

TABLE 7
Formulation for an exemplary emulsifier or additive of the present
disclosure prepared from the Partial Amides from Table 6

| | Palmitic | Stearic | AltaVeg ™- | AltaVeg ™-Stearic |
|---|---|---|---|---|
| | Acid | Acid | Stearic Acid | Acid-Palmitic |
| | Emulsifier | Emulsifier | Emulsifier | Acid Emulsifier |
| Partial | 88.62% | 89.6% | 86.35% | 86.30% |
| Amide | [525.00 g] | [525.00 g] | [525.00 g] | [525.00 g] |
| Maleic | 11.38% | 10.4% | 13.65% | 13.70% |
| Anhydride | [67.42 g] | [60.94 g] | [82.99 g] | [83.34 g] |

### Example 2: Making Oil-Based Drilling Fluid

Performance of the emulsifier or secondary emulsifier of the present disclosure was tested in an oil-based drilling fluid formulation using EnvaDry™ P-FL as the primary emulsifier. The formulation details are shown in Table 8 below. The exemplary oil-based drilling fluid was prepared by sequentially adding the ingredients listed in Table 8 and mixing for the indicated period of time with a Hamilton Beach (Glen Allen, Virginia) mixer on medium. After preparing the oil-based drilling fluid, the drilling fluid was then hot rolled at 150° F. for 16 hours. The oil-based drilling fluid was then remixed on a multi-mixer on high for 5 minutes. The 350 mL oil-based drilling fluid had a weight of 545.17 g, with an actual mud weight of 13.0 g, and oil/water ratio (OWR) of 0.80.

### Example 3: Examining the Oil-Based Drilling Fluid

The rheological properties and emulsion stability (ES) were examined according to the methods described in API Recommended Practice 13B-2, Fourth Edition, Recommended Practice for Field Testing of Oil-based Drilling Fluids. Briefly, the oil-based drilling fluid was aged for 16 hours at 250° F. under 150 pounds per square inch (psi) nitrogen using a stainless-steel rolling aging cell. After aging, the fluid was remixed using a steal mixing cup and a Hamilton Beach mixer at medium mixing speed. The rheological properties of the oil-based drilling fluid were then examined using an OFITE® 900 series rotational rheometer at 120° F. Emulsion stability (ES) was measured using an OFITE® ES meter with the fluid maintained at 120° F. High Temperature High Pressure Fluid Loss (HTHP) testing was conducted at 250° F. with a 500 psi differential between the top and bottom pressures. Separated fluid was collected from the bottom port of the HTHP apparatus to measure fluid loss of the mud during the test.

TABLE 8
Exemplary oil-based drilling fluid formulation of the present disclosure

| | Drilling | Drilling | Drilling | Drilling | Drilling | |
|---|---|---|---|---|---|---|
| | Fluid 1 | Fluid 2 | Fluid 3 | Fluid 4 | Fluid 5 | Mixing |
| Low Sulfur Diesel Oil | 218.1 mL | 218.1 mL | 218.1 mL | 218.1 mL | 218.1 mL | |
| (0.86 g/mL) | [186.95 g] | [186.95 g] | [186.95 g] | [186.95 g] | [186.95 g] | |
| VG-PLUS (1.70 g/mL; | 3.5 mL | 3.5 mL | 3.5 mL | 3.5 mL | 3.5 mL | 10 |
| amine-treated | [8.00 g] | [8.00 g] | [8.00 g] | [8.00 g] | [8.00 g] | minutes |
| bentonite clay, M-I | | | | | | |
| Swaco; Houston, | | | | | | |
| Texas) | | | | | | |
| Lime (Ca(OH)₂; 2.23 | 0.9 mL | 0.9 mL | 0.9 mL | 0.9 mL | 0.9 mL | 5 |
| g/mL) | [2.00 g] | [2.00 g] | [2.00 g] | [2.00 g] | [2.00 g] | minutes |
| Primary (3 ppb)* and | 5.3 mL | 5.3 mL | 5.3 mL | 5.3 mL | 5.3 mL | 1 |
| Secondary Emulsifiers | [5.00 g] | [5.00 g] | [5.00 g] | [5.00 g] | [5.00 g] | minute |
| (0.95 g/mL) | | | | | | |
| Secondary Emulsifier**: | 2 ppb | 2 ppb | 2 ppb | 2 ppb | 2 ppb | |
| Alta Veg ™ Emulsifier #1 | | | | | | |
| Palmitic Acid Emulsifier | | | | | | |
| Alta Veg ™ Emulsifier #2 | | | | | | |
| Stearic Acid Emulsifier | | | | | | |
| HTFA Emulsifier | | | | | | |
| 25% CaCl₂ Brine (1.23 | 54.5 mL | 54.5 mL | 54.5 mL | 54.5 mL | 54.5 mL | 10 |
| g/mL) | [66.84 g] | [66.84 g] | [66.84 g] | [66.84 g] | [66.84 g] | minutes |
| Barite (4.10 g/mL) | 67.7 mL | 67.7 mL | 67.7 mL | 67.7 mL | 67.7 mL | 5 |
| | [276.38 g] | [276.38 g] | [276.38 g] | [276.38 g] | [276.38 g] | minutes |

*Primary emulsifier is EnvaDry ™ P-FL, (Ingevity Corporation, North Charleston, South Carolina).
**Specific exemplary secondary emulsifiers of the present disclosure used in Drilling Fluids 1-5 are shown in parts per billion (ppb), but the total amount of emulsifier is shown in the row above.

The performance characteristics are shown in Table 9 below. Rheological properties and other performance factors were within typical ranges for oil-based muds.

TABLE 9
Performance properties for exemplary oil-based drilling fluid

| | Drilling | | Drilling | | Drilling | | Drilling | | Drilling | |
|---|---|---|---|---|---|---|---|---|---|---|
| | Fluid 1 | | Fluid 2 | | Fluid 3 | | Fluid 4 | | Fluid 5 | |
| Shear Stability for | 62.8 | DR | 45.0 | DR | 47.3 | DR | 55.4 | DR | 45.2 | DR |
| 600 RPM @ 150° F. | | | | | | | | | | |
| Shear Stability for | 41.3 | DR | 29.5 | DR | 30.7 | DR | 37.2 | DR | 28.0 | DR |
| 300 RPM @ 150° F. | | | | | | | | | | |
| Shear Stability for | 33.1 | DR | 21.8 | DR | 23.3 | DR | 28.7 | DR | 19.8 | DR |
| 200 RPM @ 150° F. | | | | | | | | | | |
| Shear Stability for | 25.0 | DR | 14.4 | DR | 16.2 | DR | 20.3 | DR | 13.5 | DR |
| 100 RPM @ 150° F. | | | | | | | | | | |
| Shear Stability for | 13.9 | DR | 7.8 | DR | 8.8 | DR | 11.3 | DR | 6.9 | DR |
| 6 RPM @ 150° F. | | | | | | | | | | |
| Shear Stability for | 13.5 | DR | 7.3 | DR | 8.4 | DR | 10.7 | DR | 6.7 | DR |
| 3 RPM @ 150° F. | | | | | | | | | | |
| Plastic Viscosity (PV) | 21.5 | cP | 15.5 | cP | 16.6 | cP | 18.2 | cP | 17.2 | |
| Yield Point (YP) | 19.8 lb/ | | 14.0 lb/ | | 14.1 lb/ | | 19.0 lb/ | | 10.8 lb/ | |
| | 100 feet² | | 100 feet² | | 100 feet² | | 100 feet² | | 100 feet² | |
| Gel Strength | 13 | DR | 8 | DR | 8 | DR | 11 | DR | 7 | DR |
| 10 seconds | | | | | | | | | | |
| Gel Strength | 15 | DR | 10 | DR | 11 | DR | 13 | DR | 8 | DR |
| 10 minutes | | | | | | | | | | |
| Emulsion Stability | 1102 | V | 718 | V | 752 | V | 674 | V | 652 | V |
| (ES) at 150° F. | | | | | | | | | | |
| High Temperature | 5.6 | | 4.8 | | 4.4 | | 4.4 | | 5 | |
| High Pressure Fluid | | | | | | | | | | |
| Loss @ 500 psi | | | | | | | | | | |
| High Temperature High | 9 | mm | 11 | mm | 7 | mm | 6 | mm | 11 | mm |
| Pressure Cake Thickness | | | | | | | | | | |

As mentioned above, AltaVeg™ FA 450 contains about 7000 palmitic acid, <5% stearic acid, and the balance is unsaturated C₁₈ fatty acids. It was surprising and unexpectedly discovered that increasing the palmitic and stearic acid concentration in the fatty acid raw material increased the melting temperature of the emulsifier or additive of the present disclosure, which allowed handling and storage at increased temperatures. The melting temperature of the emulsifier or additive of the present disclosure is greatly affected by the stoichiometry of the acid/anhydride chemistry when reacting the amidoamine in the second step of the synthesis.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references or publication are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range. “Combinations” is inclusive of blends, mixtures, alloys, reaction products, and the like. The terms “first”, “second”, and the like, do not denote any order, quantity, or importance, but rather are used to denote one element from another.

The terms “fluid loss control additive” and “fluid loss additive” are used interchangeably and are synonymous for the purpose of this disclosure.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An emulsifier, or an emulsifier reaction product, made by a process comprising:
reacting (A) a fatty acid composition with (B) one or more poly(alkylamine) to produce a partial amide; and
reacting (a) the partial amide with (b) an acid and/or anhydride composition that includes at least one of a dicarboxylic acid, a di-anhydride, a tricarboxylic acid, a tri-anhydride, or a mixture thereof, to produce the emulsifier,
wherein the fatty acid composition comprises at least about 60% C₁₆₋₁₈ fatty acids and at least 65% saturated fatty acids.

2. The emulsifier of claim 1, wherein the fatty acid composition comprises one or more C₁₆₋₁₈ fatty acid.

3. The emulsifier of claim 1, wherein the fatty acid composition comprises at least one of:
at least about 60% C₁₆ fatty acids and C₁₈ fatty acids;
less than about 30% unsaturated C₁₈ fatty acids; or
a combination thereof.

4. The emulsifier of claim 1, wherein the fatty acid composition comprises at least one of:
at least about 65% C₁₆ fatty acids and C₁₈ fatty acids;
less than about 25% unsaturated C₁₈ fatty acids; or
a combination thereof.

5. The emulsifier of claim 1, wherein at least one of:
the fatty acid composition comprises at least 85% saturated fatty acids;
the fatty acid composition includes at least one of palmitic acid, stearic acid, hydrogenated tallow fatty acids, or a mixture thereof;
the fatty acid composition includes: at least about 65% C₁₆ fatty acids and C₁₈ fatty acids, less than about 10% C₁₈ fatty acids, and less than about 25% unsaturated C₁₈ fatty acids; or
a combination thereof.

6. The emulsifier of claim 1, wherein the poly(alkylamine) includes at least one of 1 to 12 carbon atoms, 1 to 7 nitrogen atoms, or a combination thereof.

7. The emulsifier of claim 1, wherein at least one of:
the dicarboxylic acid includes a C₂₋₆ dicarboxylic acid;
the di-anhydride includes a C₂₋₆ di-anhydride;
the tricarboxylic acid includes a C₃₋₈ tricarboxylic acid;
the tri-anhydride includes a C₃₋₈ tri-anhydride, or
a combination thereof.

8. The emulsifier of claim 1, wherein at least one of:
the one or more poly(alkylamine) includes at least one of diethylenetriamine (DETA), triethylenetetramine (TETA), tetraethylenepentamine (TEPA), or a mixture thereof;
the acid and/or anhydride composition includes at least one of maleic acid, fumaric acid, succinic acid, succinic anhydride, maleic anhydride, or a mixture thereof; or
a combination thereof.

9. The emulsifier of claim 1, wherein at least one of:
the fatty acid composition is present in an amount of about 75 to about 90 wt % of the partial amide;
the one or more poly(alkylamine) is present in an amount of about 10 to about 25 wt % of the partial amide;
the partial amide is present in an amount of about 80 to about 95 wt % of the emulsifier;
the acid and/or anhydride composition is present in an amount of about 5 to about 20 wt % of the emulsifier; or
a combination thereof.

10. The emulsifier of claim 1, wherein at least one of:
the molar ratio of the fatty acid composition to the poly(alkylamine) is about 1.85 to about 2.0;
the molar ratio of the partial amide to the acid and/or anhydride composition is about 0.6 to about 1.0;
the emulsifier has at least one of an acid number of about 45 to about 80, an amine number of about 5 to about 15, or a combination thereof; or
a combination thereof.

11. (canceled)

12. The emulsifier of claim 1, wherein reacting the fatty acid composition with the poly(alkylamine) comprises at least one of:
heating the fatty acid composition to produce a molten fatty acid composition;
adding the acid and/or anhydride composition to the fatty acid composition;
agitating the fatty acid composition and the one or more poly(alkylamine) reaction mixture;
reacting the fatty acid composition and the acid and/or anhydride composition at about 145° C. to about 185° C. until the acid number (AN) is less than about 20 mg/g; or
a combination thereof.

13. The emulsifier of claim 1, wherein reacting the partial amide with the acid and/or anhydride composition comprises at least one of:
heating the partial amide to about 100° C. to about 140° C.;
adding the acid and/or anhydride composition to the partial amide;
agitating the partial amide and the acid and/or anhydride composition reaction mixture;
reacting the partial amide and the acid and/or anhydride composition at about 130° C. to about 165° C.;
reacting the partial amide and the acid and/or anhydride composition for about 30 minutes to about 90 minutes; or
a combination thereof.

14. The emulsifier of claim 1, wherein at least one of:
the method further comprises cooling the emulsifier;
the emulsifier does not include a support material, a solid support, a solvent, a diluent, an absorbent, a pour point depressant, any additives, or a combination thereof;
the emulsifier only includes the emulsifier reaction product;
the emulsifier consists of the emulsifier reaction product; or
a combination thereof.

15. The emulsifier of claim 14, wherein the emulsifier is a solid.

16. The emulsifier of claim 15, further comprising mechanically breaking the emulsifier solid to a particulate.

17. (canceled)

18. A method of making an emulsifier of claim 1, the method comprising:
reacting (A) a fatty acid composition with (B) one or more poly(alkylamine) to produce a partial amide; and
reacting (a) the partial amide with (b) an acid and/or anhydride composition that includes at least one of a dicarboxylic acid, a di-anhydride, a tricarboxylic acid, a tri-anhydride, or a mixture thereof, to produce the emulsifier,
wherein the fatty acid composition comprises at least about 60% C₁₆₋₁₈ fatty acids and at least 65% saturated fatty acids.

19. An oil-based drilling fluid comprising an invert emulsion of a hygroscopic liquid, one or more emulsifier, and at least one of: an oil, a mineral oil, a synthetic oil, or a combination thereof,
wherein the one or more emulsifiers includes the emulsifier of claim 1.

20. The oil-based drilling fluid of claim 19, wherein at least one of:
the one or more emulsifiers includes, consists essentially of, or consists of a primary emulsifier;
the oil is diesel;
the hygroscopic liquid is a CaCl₂ brine, a NaCl brine, a NaBr brine, a CaBr₂ brine, a formate brine, a potassium formate, an alcohol based hygroscopic liquid, a lower polyhydric alcohol, glycerol, or polyglycerol;
the oil-based drilling fluid further comprises at least one of one or more weighting agent, one or more rheological modifier, one or more alkalinity agent, one or more wetting agent, or a combination thereof; or
a combination thereof.

21. (canceled)

22. The oil-based drilling fluid of claim 19, wherein the oil-based drilling fluid comprises an invert emulsion of a hygroscopic liquid, an oil, a mineral oil, the emulsifier, and an internal olefin.

23. A method of drilling a wellbore, the method comprising circulating the oil-based drilling fluid of claim 19 through the wellbore when drilling.
